(19) United States
(12) Patent Application Publication
(10) Pub. No.: US 2006/0047528 A1
(43) Pub. Date: Mar. 2, 2006

(54) Internet service for facilitating delivery of inquiries and answers, and accounting for associated financial transactions

(76) Inventors: Steven W. Johnson, Woodbury, MN (US); Ayodele M Alaran, Atlanta, GA (US); Christos Mousakas, Los Angeles, CA (US)

Correspondence Address: WALTER K. ROLOFF, 490 HARBOR COURT, SHOREVIEW, MN, 55126, US

(21) Appl. No.: 10/930,354

(22) Filed: Aug. 31, 2004

(51) Int. Cl. G06Q 99/00

(52) U.S. Cl. 705/1; 705/16; 705/26

(57) ABSTRACT

An internet service for facilitating delivery of inquiries and answers thereto, and accounting for financial transactions associated therewith includes means for (i) a user of the service to specify a geographic region of interest to the user, (ii) the user to broadcast an inquiry to a subscriber population, with the subscriber population being associated with the geographic region of interest to the user, (iii) means for the subscriber population to receive the inquiry from the user so that an evaluation may be made by the subscriber population of whether to answer the inquiry, (iv) means for the subscriber population desiring to answer the inquiry to advise the user of a value associated with their answers to be given to the user upon acceptance of the value by the user, (v) means for the user to view an answer selected by the user upon acceptance of the value by the user, and (vi) means for accounting for the value as a debit against an account of the user in the service and as a credit to an account of each one of the subscriber population giving an answer selected by the user.

### FIELD OF THE INVENTION

The present invention relates generally to internet-based information systems. The invention relates specifically to an internet service for facilitating delivery of inquiries and answers, and accounting for financial transactions associated therewith.

### BACKGROUND OF THE INVENTION

Before personal computers were commonplace, information was most expeditiously exchanged between individuals or small groups through informal, unstructured channels such as via written correspondence, telephones, or just by having a conversation over the backyard fence. Pertinent information was effectively exchanged thereby, based on a spirit of community and cooperation. As technological advances have been made, particularly over about the past twenty years, and as society has seemingly become more mobile, active, and independently-minded, the informal, unstructured channels of communication have become much less common and effective. Thus, internet-based information systems have revolutionized the exchange of ideas worldwide. Indeed, the recent initial public offering of stock in Google Inc. was heralded with great anticipation and success.

As is well known, internet-based information systems, including “search engines” and associated features such as electronic “bulletin boards”, “chat rooms”, expert-based systems, and the like (collectively, hereinafter, “internet services”) have become prevalent in the exchange of information between individuals. For example, internet-based information systems such as “Google”™ utilize various techniques in operation, having certain similarities. In a basic and typical question-and-answer or “internet search” session, a user connects to the internet through a commercial communication provider, and then accesses a desired on-line/on-screen internet service (e.g., the aforementioned “Google”, or “Yahoo!”, among many others) via a website. The user then inputs, on-screen, a Boolean or “key word” query (search) as directed by the internet service's website and obtains an on-screen list of search results. The search results are commonly “hyperlinked” such that the user need only “click” on a result that appears to be of interest, to access a web page corresponding to that result.

Regarding revenue associated with internet services, a system such as that of “google.com” generates profits by providing advertisers with an opportunity to deliver online advertising that is relevant to information displayed on pages of the website. In particular with respect to google.com, the service claims to distinguish advertisements from search results or other content on a page so that the user knows when someone has paid to display a message thereon; specifically, google.com claims to not sell placement in the search results themselves, or allow parties to pay for a higher ranking thereon.

In general, several concepts relating to an exchange of information via the internet have been patented. Among these are U.S. Pat. No. 5,948,054 issued to Nielsen, and U.S. Pat. No. 6,064,978 issued to Gardner, et al.

In the Nielsen patent, a “pool of experts” is utilized to answer a customer's query. Specifically, a customer sends an information request to a server via the customer's computer. The request, which includes a question that the customer wishes to have answered, does not specify a consultant from which the answer may be obtained. In response, the server determines which consultants are qualified to provide the requested information. The server then solicits the requested information from the qualified consultants. If at least one of the qualified consultants decides to provide the requested information, then the server receives the information from the consultant via one of the consultant computers. Thereafter, the server sends the information to the customer via the customer's computer. In this manner, the server matches the customer's query with a consultant's answer. By doing so, the sever enables the customer to obtain an answer to the query without first knowing which consultant has sufficient knowledge to provide the answer.

In the Gardner, et al. patent, a method for regulating the asking, and motivating the answering, of questions via a computer network is disclosed. The number and complexity of questions asked is controlled by a question regulation method, and the number and quality of answers provided is controlled by an answer evaluation method. The question regulation method permits users to post more numerous or more complex questions based on factors such as viewing of advertising, or provision of marketing information. The answer measurement method may be used to reward those who supply numerous or high-quality answers with premiums, public recognition, or employment opportunities.

Several drawbacks exist, however, relative to the generally known information exchange methods and those that are patented as aforedescribed. Among these drawbacks are a lack of capability of ongoing dialog between users (inquirers) and consultants (answerers) coupled with a lack of specificity as to a user's geographic region of interest.

Therefore, there exists a need for an internet service for facilitating delivery of inquiries and answers, and accounting for financial transactions associated therewith, which overcomes the drawbacks of the well known services and information exchange techniques.

### SUMMARY OF THE INVENTION

An object of the present invention is to provide an internet service for facilitating delivery of inquiries and answers thereto, and accounting for financial transactions associated therewith, which generally overcomes the drawbacks of the well known services and information exchange techniques.

Another object of the present invention is to provide an internet service for facilitating delivery of inquiries and answers thereto, and accounting for financial transactions associated therewith, which particularly provides specificity as to a user's geographic region of interest.

In accordance with the present invention, an internet service for facilitating delivery of inquiries and answers thereto, and accounting for financial transactions associated therewith, includes means for (i) a user of the service to specify a geographic region of interest to the user, (ii) the user to broadcast an inquiry to a subscriber population, with the subscriber population being associated with the geographic region of interest to the user, (iii) means for the subscriber population to receive the inquiry from the user so that an evaluation may be made by the subscriber population of whether to answer the inquiry, (iv) means for the subscriber population desiring to answer the inquiry to advise the user of a value associated with their answers to be given to the user upon acceptance of the value by the user, (v) means for the user to view an answer selected by the user upon acceptance of the value by the user, and (vi) means for accounting for the value as a debit against an account of the user in the service and as a credit to an account of each one of the subscriber population giving an answer selected by the user.

### BRIEF DESCRIPTION OF THE DRAWINGS

FIG. 1 is a schematic diagram of a non-internet-based information exchange technique of the prior art.

FIG. 2 is a schematic diagram of an internet-based information exchange technique of the prior art.

FIG. 3 is a schematic diagram of another internet-based information exchange technique of the prior art.

FIG. 4 is a schematic diagram of an internet service for facilitating delivery of inquiries and answers thereto, and accounting for financial transactions associated therewith, of the present invention.

FIG. 5 is a flow diagram of a process in an internet service for facilitating delivery of inquiries and answers thereto, and accounting for financial transactions associated therewith, of the present invention.

### DETAILED DESCRIPTION OF THE INVENTION

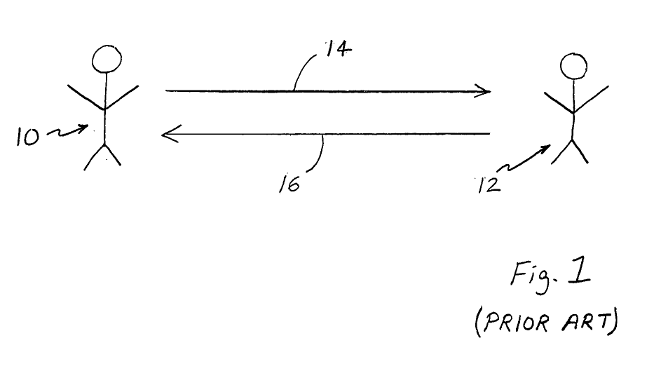

Referring to FIG. 1, there shown is a schematic diagram of a prior art non-internet-based information exchange technique between two individuals 10 and 12. In such a well-known technique, individual 10 queries individual 12 by way of communication link 14. Individual 12 then responds to the inquiry by way of communication link 16. Additional inquiries and associated answers may be communicated between individuals 10 and 12, with both individuals having a capability to selectively query and provide answers to each other. Communication links 14 and 16 may take a virtually limitless number of forms, including spoken communication (e.g., a conversation over the backyard fence), sign language for the hearing impaired, written communication between distant individuals, telephonic or e-mail communication, or even light signals as utilized in air traffic control. As used here throughout, “communication link” is intended to include any means for providing point-to-point communication and for facilitating delivery of inquiries and answers.

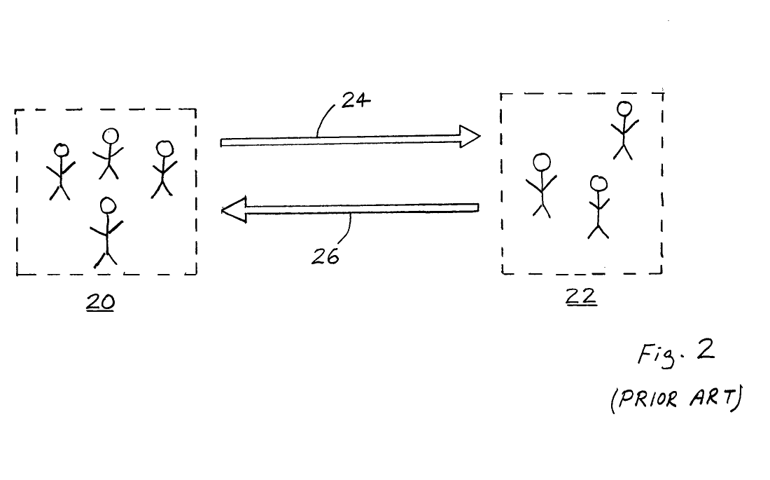

Another exemplary prior art technique for facilitating delivery of inquiries and answers is depicted in FIG. 2. Therein, two groups of individuals, 20 and 22, selectively make inquiries and answers via communication links 24 and 26. When links 24 and 26 are provided through linked computers in an internet service, the technique is commonly referred to as a “chat room”. In such a technique, inquiries are broadcast (for example, from one or more individuals in group 20 via link 24) to group 22, whereupon one or more individuals in group 22 then may broadcast associated answers back to group 20 via link 26.

Of course, variations in both prior art techniques exemplified in FIGS. 1 and 2 are possible, with myriad combinations of inquiries and answers being provided among the individuals, and various communication links being utilized.

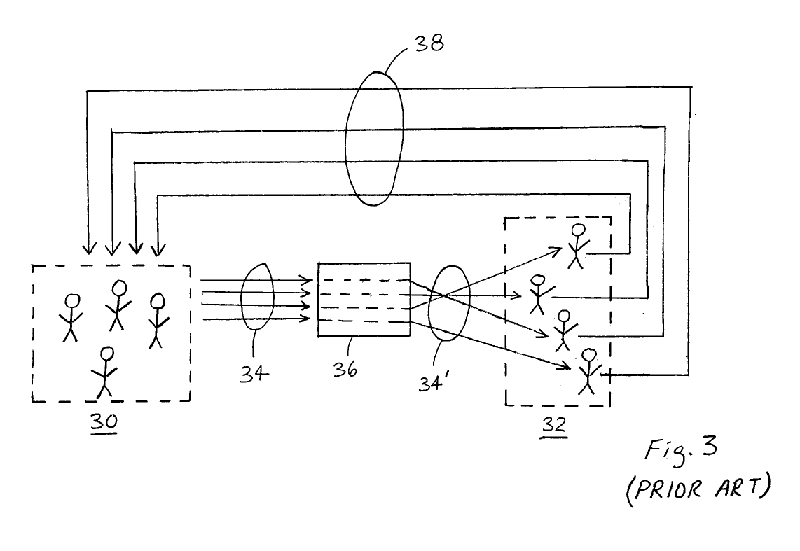

FIG. 3 is a schematic diagram of another exemplary prior art internet-based information exchange technique. In this so-called “expert based system” (e.g., the aforementioned U.S. Pat. No. 5,948,054) groups of individuals, 30 and 32, selectively make inquiries and answers via communication links 34 and 38. Particularly, links 34 are routed to a central computer (the expert system) 36 whereupon individual inquiries are routed via links 34′ to specific individuals in group 32 who have been selected by central computer 36 as being most suited to answer a given inquiry. Then, the selected individual from group 32 broadcasts the answer back to group 30. Variations in this exemplary prior art technique, like the examples of FIGS. 1-2, are also possible, with myriad combinations of inquiries and answers being provided among the individuals and/or groups, and various communication links being utilized.

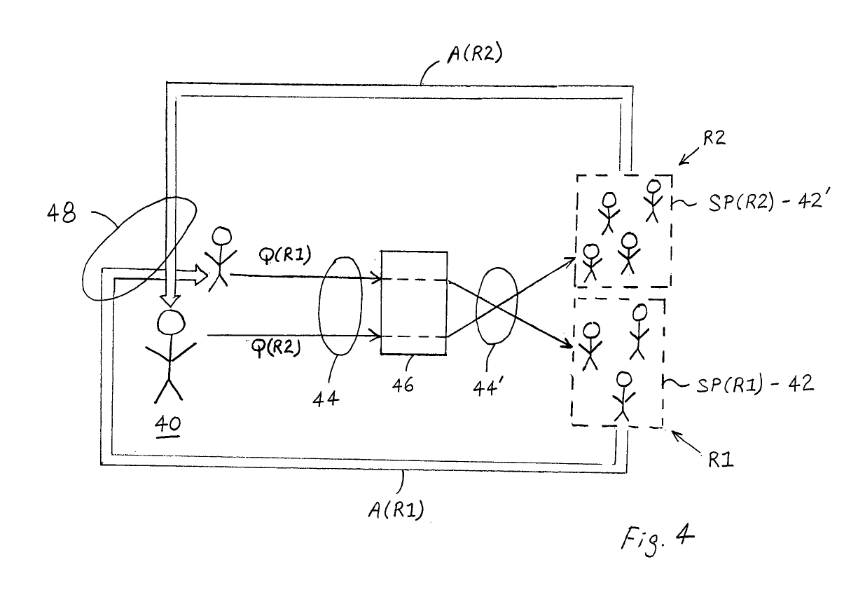

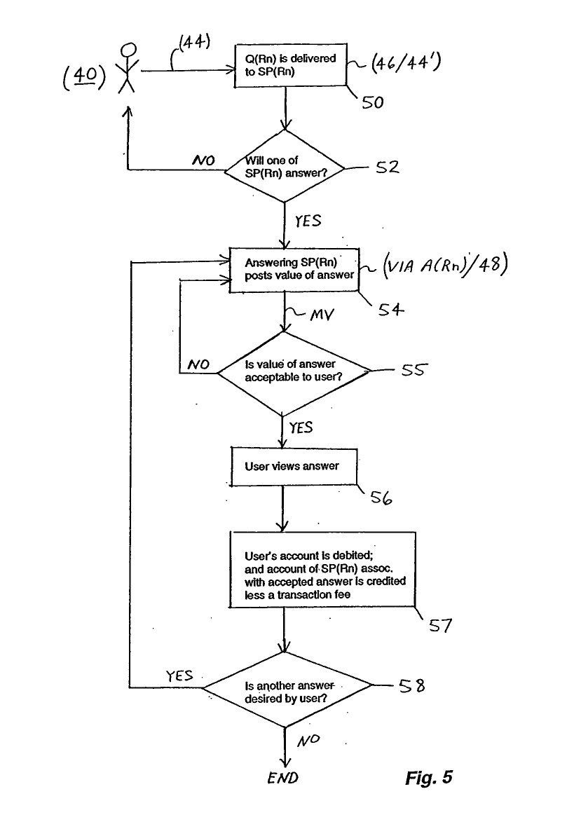

Referring now to FIGS. 4 and 5, there depicted is (i) an exemplary schematic diagram of an internet service for facilitating delivery of inquiries and answers thereto, and accounting for financial transactions associated therewith, of the present invention, and (ii) an exemplary flow diagram of a process of the present invention within the service, respectively.

In exemplary FIG. 4, users 40 in an internet service communicate their inquiries to subscriber populations 42 and 42′ defined by geographic regions R1 and R2, respectively. Thus, subscriber populations 42 and 42′ are further denoted in the figure as SP(R1) and SP(R2), respectively. In one embodiment of the invention, regions R1 and R2 (through Rn as may be desired, although not depicted) are defined by postal zip codes that are programmed to be recognized by the internet service. It is to be understood that the internet service of the present invention, as exemplified in FIGS. 4-5, functions primarily for facilitating delivery of inquiries and answers, and for accounting for financial transactions associated therewith as will be further described. The defining of geographic regions R1 through Rn may be accomplished by any suitable means whereby users 40 may specify geographic regions of interest to them.

Next, users 40 broadcast their inquiries Q(R1) through Q(Rn), associated with the identified geographic regions R1 through Rn, to subscriber populations SP(R1) through SP(Rn), accordingly. The broadcasting of inquiries Q(Rn) is accomplished by way of communication links 44 and 44′, as routed through central computer 46 according to geographic region. In this way, Q(R1) is routed to SP(R1), and so on. It is to be recognized that the defining of geographic regions Rn and routing inquiries accordingly, is of paramount importance to the successful operation of the service of the present invention. Specifically, inquiries Q(Rn) of users 40 are delivered to those members of a subscriber population SP(Rn) who are most likely to know and intelligently communicate an answer desired by the user.

Subscriber population SP(Rn) then receives inquiries Q(Rn) via link 44′ from computer 46 by any suitable internet means, so that individuals within subscriber population SP(Rn) may evaluate whether to answer any of the inquiries Q(Rn). Upon making their evaluations of inquiries Q(Rn), population SP(Rn) then advise users 40 of a monetary value associated with their answers A(Rn) to be given to the user upon acceptance of the monetary value by the user, again by any suitable internet means. Although not depicted in FIG. 4, such monetary values are preferably attached to or “lock” associated answers A(Rn) and are communicated to users 40 through communication links 48; in this manner of one embodiment of the present invention, and as will be further described with reference to FIG. 5, answers A(Rn) are not available to users 40 until users 40 accept the associated monetary values.

Upon acceptance of a monetary value associated with an answer A(Rn), a user 40 then is provided with an ability to view or reveal the particular answer A(Rn), again by any suitable internet means.

After viewing or otherwise being able to reveal the answer, a debit is made against an account of the user in the service; and a corresponding credit is made to an individual of the subscriber population providing the answer selected by the user. Although not depicted in FIG. 4, this means for accounting for the value in terms of a debit to user 40 asking Q(Rn) and a credit to a member of subscriber population SP(Rn) providing A(Rn), will be further described in FIG. 5. Alternatively, in a “shareware” type embodiment, the aforedescribed accounting involving debiting and crediting may be, for example, selectively voluntary as determined by users 40 and/or individuals of subscriber populations SP(Rn).

Referring particularly, now, to FIG. 5, an exemplary flow diagram of a process of the present invention within the aforedescribed service is presented; FIG. 5 is intended to further illuminate those means already described with reference to FIG. 4.

In FIG. 5, the exemplary process begins with users 40 submitting inquiries (Q(Rn)) at 50 to the service (46, via links 44) with the service in turn, delivering the inquiries (via links 44′) to the subscriber population (SP(Rn)) according to their geographic regions (Rn) as initially specified by users 40. If none of the selected population will answer at 52, users 40 are so notified that their inquiries failed. If at least one of the population does decide to answer at 52, then the answering population posts at 54 (via links 48) a corresponding monetary value MV associated with their answers A(Rn). Upon acceptance of a monetary value MV associated with a particular answer A(Rn), a user 40 then is provided with the answer at 56. After being provided with the answer, a debit is made against an account of the user in the service at 57; and a corresponding credit is made to an individual of the subscriber population providing the answer also at 57. Preferably, to provide profitability for the service, transaction fees are assessed to the accounts of the subscriber population giving accepted answers to the users, as a percentage of the corresponding monetary values MV. If another answer is desired by a user at 58, the process continues by returning to 54; otherwise, the process ends.

Although not depicted in the drawings, other embodiments of the present invention may be preferred for a given application. For example, the present invention may also include suitable means (i) for the user to evaluate the subscriber population based on feedback from at least one other user, or (ii) for the user to determine compatibility with the subscriber population, or (iii) for the user to determine compatibility with at least one other user. These additional features may be advantageously employed alone in the invention as aforedescribed, or in combination with each other. These various evaluation and compatibility determination means may be provide via any suitable internet technique, such as by scoring and the like or by semi-subjective criteria including weighting functions, etc.

Computer programming for the internet service of the present invention is preferably accomplished by way of a combination of HTML, XML, SQL and C+ programming languages and related techniques.

Further alternative exemplary embodiments of the internet service of the present invention are as follows:

### EXAMPLE 1

The service further includes means for users to hold private communications with members of the subscriber population giving answers selected by the users, and vice versa. Such means may be provided by, for example, the posting of a message by a user into a table that is created within a subscriber population database of the service.

### EXAMPLE 2

The service further includes means for the users to record performance feedback of the members of the subscriber population giving answers selected by the users. Such means may be provided by, for example, the posting of a message and a numeric score by a user into a table that is created within a database of the service, which may be read by other users.

### EXAMPLE 3

The service further includes means for the users to characterize their inquiries so that the subscriber population may readily determine the scope of the inquiries. Such means may be provided by, for example, the selection by a user of a category from a list of available categories of inquiries within the service, whereupon the selected category is associated or “linked” by the service with user's inquiry which, in turn, resides in a table in the service.

The foregoing disclosure has been made with reference to private individuals being the users and subscriber population of the service of the present invention. However, the present invention also contemplates that some members of the subscriber population could be commercial enterprises. A commercial enterprise would preferably pay the service upon an occurrence of a user viewing an answer of the commercial enterprise, or of the commercial enterprise simply having an opportunity to answer an inquiry. Therefore, the following examples are alternative embodiments of the internet service of the present invention in such a commercial context:

### EXAMPLE 4

The service further provides that the answer is freely and publicly available through the internet service, with the commercial enterprises paying the service for each viewing of their answers. Such provision may be made, for example, by a commercial enterprise being required by the service to deposit a sum of money into a deposit account, with a withdrawal therefrom being made by the service upon an occurrence of a user viewing an answer provided by the commercial enterprise.

### EXAMPLE 5

The service further provides that the user may view previous inquiries. Such provision may be made, for example, by permitting a user to run a search for previous inquiries based upon a selected geographic region and surrounding radius therefrom.

### EXAMPLE 6

The service further provides that the users may view previous answers associated with previous inquiries. Such provision may be made, for example, by the manner described in Example 5.

Without specific regard to any of the above exemplary embodiments, it is to be particularly appreciated that novelty of the present invention exists in the facts that (a) needed information that is useful to daily life might be “just around the block”; and (b) the geographically-defined subscriber population is paid through the service to answer inquiries, thereby effectively being paid consultants or experts to others through the service without a need for separate advertising or listing through directories and the like.

It is also to be appreciated that the present invention may be utilized by both private and commercial subscriber populations alike, or any combinations thereof, to ask and answer their own questions as a technique for selling their answers; in such cases the inquiries are not broadcast to other subscribers for answers but the inquiries and answers are available to those who use a “Search for Answers” capability of the service as described in Example 6, above.

It is to be further appreciated that any member of the subscriber population may act as a private member for one answer and as a commercial enterprise for another; for example, a teenage girl may answer an inquiry about hair salons privately based on her experience in her geographic region and answer another inquiry about baby sitting commercially as a means to advertise her baby sitting services in the region. Similarly, for example, an individual who runs a lawn service in a particular locale may answer an inquiry about preferred hardware stores based on his experience in his geographic region and answer another inquiry about lawn care commercially as a means to advertise his lawn care services in the region.

It is to be understood that users and subscribers as have been mentioned here throughout may be of the same group or “pool”; that is, once a user or subscriber is registered, inquiries may be made and answered without regard to a given designation herein as being a user or subscriber.

While the present invention has been particularly shown and described with reference to the accompanying figures, it will be understood, however, that other modifications thereto are of course possible, all of which are intended to be within the true spirit and scope of the present invention. It should be appreciated that components, means, and features of the invention aforedescribed may be substituted for other suitable components, means, and features for achieving desired results, or that various accessories may be added thereto, or that various combinations of the components, means, and features of the invention may be made. Also, where concepts have been described in a singular sense, a plural meaning is intended to be equally relevant and vice versa. Additionally, the foregoing examples presented are not limiting and are for illustration of capabilities of the invention and for comprehension and understanding thereof.

Lastly, the choice, of course, of various aforementioned components or features of embodiments of the present invention are all a matter of design choice depending upon intended uses thereof.

Accordingly, these and other various changes or modifications in form and detail of the present invention may also be made therein, again without departing from the true spirit and scope of the invention as defined by the appended claims.

I claim:

1. An internet service for facilitating delivery of inquiries and answers, and accounting for financial transactions associated therewith, said internet service comprising:
means for a user of said service to specify at least one geographic region of interest to said user, in said service;
means for said user to broadcast at least one inquiry to a subscriber population, said subscriber population being associated with said at least one geographic region of interest to said user;
means for said subscriber population to receive said at least one inquiry from said user of said service so that an evaluation may be made by said subscriber population of whether to answer said at least one inquiry;
means for said subscriber population desiring to answer said at least one inquiry to advise said user of a value associated with their answers to be given to said user upon acceptance of said value by said user;
means for said user to view an answer selected by said user upon acceptance of said value by said user; and
means for accounting for said value as (i) a debit against an account of said user in said service and (ii) a credit to an account of each one of said subscriber population giving said answer selected by said user.

2. The internet service of claim 1, further comprising means for said user to evaluate said subscriber population based on feedback from at least one other user.

3. The internet service of claim 1, further comprising means for said user to determine compatibility with said subscriber population.

4. The internet service of claim 1, further comprising means for said user to determine compatibility with at least one other user.

5. The internet service of claim 1, further comprising means for said user to hold private communication with at least one of said subscriber population giving said answer selected by said user.

6. The internet service of claim 1, further comprising means for said user to record performance feedback of each one of said subscriber population giving said answer selected by said user.

7. The internet service as in claim 1, further comprising means for said user to characterize said inquiry so that said subscriber population may readily determine the scope of the inquiry.

8. The internet service as in claim 1, wherein at least one of said subscriber population is a commercial enterprise.

9. The internet service as in claim 8, wherein said at least one commercial enterprise pays said internet service upon an occurrence selected from the group consisting of (i) when said user views said answer and (ii) when said at least one commercial enterprise has an opportunity to answer said inquiry.

10. The internet service as in claim 9, wherein said answer is freely and publicly available through said internet service and said at least one commercial enterprise pays said internet service for each viewing of said answer.

11. The internet service as in claim 1, wherein said user may view at least one previous inquiry.

12. The internet service as in claim 1, wherein said user may view at least one previous answer associated with at least one previous inquiry.

13. The internet service as in claim 8, wherein said user may view at least one previous inquiry.

14. The internet service as in claim 8, wherein said user may view at least one previous answer associated with at least one previous inquiry.

15. An internet service for facilitating delivery of inquiries and answers, and accounting for financial transactions associated therewith, said internet service comprising:
means for a user of said service to broadcast at least one inquiry to a subscriber population, said subscriber population being defined by at least one selected geographic location;
means for said subscriber population to receive said at least one inquiry from said user of said service so that an evaluation may be made by said subscriber population of whether to answer said at least one inquiry;
means for said subscriber population desiring to answer said at least one inquiry to advise said user of a value associated with their answers;
means for said user to view an answer selected by said user; and
means for accounting for said value as a debit against said account of said user upon voluntary payment by said user.

16. The internet service of claim 15, further comprising means for said user to evaluate said subscriber population based on feedback from at least one other user.

17. The internet service of claim 15, further comprising means for said user to determine compatibility with said subscriber population.

18. The internet service of claim 15, further comprising means for said user to determine compatibility with at least one other user.

19. The internet service of claim 15, further comprising means for said user to hold private communication with at least one of said subscriber population giving said answer selected by said user.

20. The internet service of claim 15, further comprising means for said user to record performance feedback of each one of said subscriber population giving said answer selected by said user.

21. The internet service as in claim 15, further comprising means for said user to characterize said inquiry so that said subscriber population may readily determine the scope of the inquiry.

22. The internet service as in claim 15, wherein at least one of said subscriber population is a commercial enterprise.

23. The internet service as in claim 22, wherein said at least one commercial enterprise pays said internet service upon an occurrence selected from the group consisting of (i) when said user views said answer and (ii) when said at least one commercial enterprise has an opportunity to answer said inquiry.

24. The internet service as in claim 23, wherein said answer is freely and publicly available through said internet service and said at least one commercial enterprise pays said internet service for each viewing of said answer.

25. The internet service as in claim 15, wherein said user may view at least one previous inquiry.

26. The internet service as in claim 15, wherein said user may view at least one previous answer associated with at least one previous inquiry.

27. The internet service as in claim 22, wherein said user may view at least one previous inquiry.

28. The internet service as in claim 22, wherein said user may view at least one previous answer associated with at least one previous inquiry.
